(19) United States
(12) Patent Application Publication
(10) Pub. No.: US 2002/0021296 A1
(43) Pub. Date: Feb. 21, 2002

(54) Information display apparatus

(75) Inventors: Sadafusa Tsuji, Tondabayashi-Shi (JP); Katsuyuki Nanba, Sakai-Shi (JP); Katsuhiko Asai, Takatsuki-Shi (JP); Masahiko Matsuura, Suita-Shi (JP); Makiko Mandai, Takatsuki-Shi (JP)

Correspondence Address: SIDLEY AUSTIN BROWN & WOOD, 717 NORTH HARWOOD, SUITE 3400, DALLAS, TX, 75201, US

(73) Assignee: MINOLTA CO., LTD.

(21) Appl. No.: 09/741,705

(22) Filed: Dec. 19, 2000

(30) Foreign Application Priority Data
Dec. 24, 1999 (JP) 11-366342

(51) Int. Cl. G06T 1/00

(52) U.S. Cl. 345/418

(57) ABSTRACT

Disclosed is an information display apparatus that comprises two display screens for displaying one display frame of display information comprising display units thereon. The display frame is divide into two divided frames so that the divided display frames are respectively displayed on the display screens. According to characteristic of the display units, first and dividing processes are selectively executed. In a case where the display unit originally reaches a position at which the display unit is to be displayed across the plurality of display screens, in the first process, the display information is processed so that each display unit are prevented from divided, while in the second process, the display information is executed so as to be divide the display unit and applies the parts of the divided display unit to the plurality of display screens.

### CROSS REFERENCE TO RELATED APPLICATION

This application is based on Japanese Patent Application No. Hei 11-366342 filed in Japan on Dec. 24, 1999, the entire content of which is hereby incorporated by reference.

### BACKGROUND OF THE INVENTION

1. Field of the Invention

The present invention relates to an information display apparatus, and more particularly, to an information display apparatus that displays digital information on a display as, visible information.

2. Description of the Related Art

Display apparatuses that perform display of one frame by means of multiple display screens (such as liquid crystal display elements) are conventionally known. In particular, in Japanese Laid-Open Patent Application Hei 11-161458, an information display apparatus is disclosed in which, in order to prevent the information from being displayed across two display screens, the information is moved and displayed on one of the display screens, and contents of the information is thereby displayed without being divided.

However, in this display apparatus, where there is a large amount of text information, there is a risk that the number of characters that may be displayed is reduced when moving the text information to prevent such division. Moreover, in the case of graphics information, it often occurs that a single unit of display information is too large to allow it to be moved to one of the displays.

### SUMMARY OF THE INVENTION

Therefore, an object, of the present invention is to provide an information display apparatus by which information can be displayed in an easy-to-read fashion at all times through the effective use of multiple display screens.

In order to attain the object, an information display apparatus reflecting one of novel aspects of the present invention comprises: a plurality of display screens for displaying a display frame of display information that is formed of at least one display unit; and a division processor for dividing the display frame into a plurality of divided frames so that the divided display frames are respectively displayed on the plurality of display screens, wherein the division processor operates, based on the characteristics of the display information, according to a first process in which the information is processed such that an entire of the at least one display unit belongs one of the display frames, or a second process in which the display information is processed such that, when the at least one display unit reaches a position at which the at least one display unit is to be displayed across the plurality of display screens, the at least one display unit is divided into a plurality of parts and the plurality of parts of the divided display unit respectively belong the divided frames.

In this information display apparatus, the first process avoids displaying the display unit across the plurality of display screens. Therefore, the difficulty of reading the display unit comprising text data, etc. that arises when the display unit is displayed across the plurality of display screens can be effectively eliminated. The second process displays the display information across the plurality of display screens, even where the display information comprises a single display unit. By using the second process for display information such as graphics data, a display that is close to the original may be attained, even though the display is divided across multiple display screens.

The first process and the second process may be selected based on a size of the display unit. In this case, the first process may be executed when the size of the display unit is smaller than a prescribed value, while the second process may be executed when the size of the display unit is larger than a prescribed value. In this case, the size may be a size with respect to the across direction. For instance, the size may be a height of the display unit in a case where the display screens are aligned in a vertical direction.

The first process and the second process may be selected based on a number of pixels of the display unit. In this case, the first process may be executed when the number of pixels of the display unit is smaller than a prescribed value, while the second process may be executed when the number of pixels of the display unit is larger than a prescribed value. In this case, the number of pixels may be a number with respect to the across direction. For instance, the number may be a pixel number in a height direction of the display unit in a case where the display screens are aligned in a vertical direction.

The first process may be executed when the display unit is text data, while the second process may be executed when the display unit is not text data.

An information display apparatus reflecting other aspect of the present invention comprises: a plurality of display screens for displaying a display frame of information that is formed of at least one display unit; and a division processor for dividing the display frame into a plurality of divided frames so that the divided display frames are displayed on the plurality of display screens, wherein this division processor enlarges the display unit when the display unit originally reaches a position at which the display unit is to be displayed across the plurality of display screens, and divides the enlarged display unit into a plurality of parts so that the parts of the divided display unit is applied to the plurality of display frames.

According to this information display apparatus, the enlarged display unit is displayed across the plurality of display screens. Therefore, the difficulty of reading the display unit comprising text data, etc. that arises when the display unit has small size and is merely displayed across the plurality of display screens can be effectively eliminated.

The enlargement of the display unit may be executed when a number of pixels of the display unit is smaller than a prescribed value.

An information display apparatus reflecting still further aspect of the present invention comprises: a plurality of display screens for displaying a display frame of display information that is formed of at least one display unit; and a division processor for dividing the display frame into a plurality of divided frames so that the divided display frames are respectively displayed on the plurality of display screens, wherein the division processor selectively operates in one of a first process and a second process based on a characteristics of the display information, wherein, in the first process, the division processor processes the display information so that an entire of the at display unit belongs one of the display frames even in a case where the display unit originally reaches a position at which the display unit is to be displayed across the plurality of display screens, and wherein, in the second process, the division processor processes the display information so as to divide the display unit and applies the parts of the divided display unit to the plurality of display screens in a case where the display unit originally reaches a position at which the display unit is to be displayed across the plurality of display screens.

In this information display apparatus, the first process avoids displaying the display unit across the plurality of display screens. Therefore, the difficulty of reading the display unit comprising text data, etc. that arises when the display unit is displayed across the plurality of display screens can be effectively eliminated. The second process displays the display information across the plurality of display screens, even where the display information comprises a single display unit. By using the second process for display information such as graphics data, a display that is close to the original may be attained, even though the display is divided across multiple display screens.

The first process and the second process may be selected based on a size of the display unit. In this case, the first process may be executed when the size of the display unit is smaller than a prescribed value, while the second process may be executed when the size of the display unit is larger than a prescribed value. In this case, the size may be a size with respect to the across direction. For instance, the size may be a height of the display unit in a case where the display screens are aligned in a vertical direction.

The first process arid the second process may be selected based on a number of pixels of the display unit. In this case, the first process may be executed when the number of pixels of the display unit is smaller than a prescribed value, while the second process may be executed when the number of pixels of the display unit is larger than a prescribed value. In this case, the number of pixels may be a number with respect to the across direction. For instance, the number may be a pixel number in a height direction of the display unit in a case where the display screens are aligned in a vertical direction.

The first process may be executed when the display unit is text data, while the second process may be executed when the display unit is not text data.

### BRIEF DESCRIPTION OF THE DRAWINGS

These and other objects, advantages and features of the invention will become apparent from the following description thereof taken in conjunction with the accompanying drawings in which:

FIGS. 1(A) and 1(B) respectively show a plan view and a side view of the use mode of an information display apparatus comprising one embodiment of the present invention;

FIGS. 2(A) and 2(B) respectively show a plan view and a side view of the storage mode of the information display apparatus;

FIG. 3 is a block diagram showing in a simplified fashion the electronic meeting system using the information display apparatus pertaining to the present invention;

FIG. 4 is a block diagram showing the controller for the information display apparatus pertaining to the present invention;

FIG. 5 is a flow chart showing the display process performed by the information display apparatus pertaining to the present invention;

FIG. 6 is a flow chart showing a first example of the display division process;

FIG. 7 is a flow chart showing a second example of the display division process;

FIG. 8 is a flow chart showing a third example of the display division process; and

FIG. 9 is a drawing showing the use mode of the information display apparatus described above.

### DETAILED DESCRIPTION OF THE PREFERRED EMBODIMENTS

Embodiments of the information display apparatus pertaining to the present invention will be explained below with reference to the accompanying drawings.

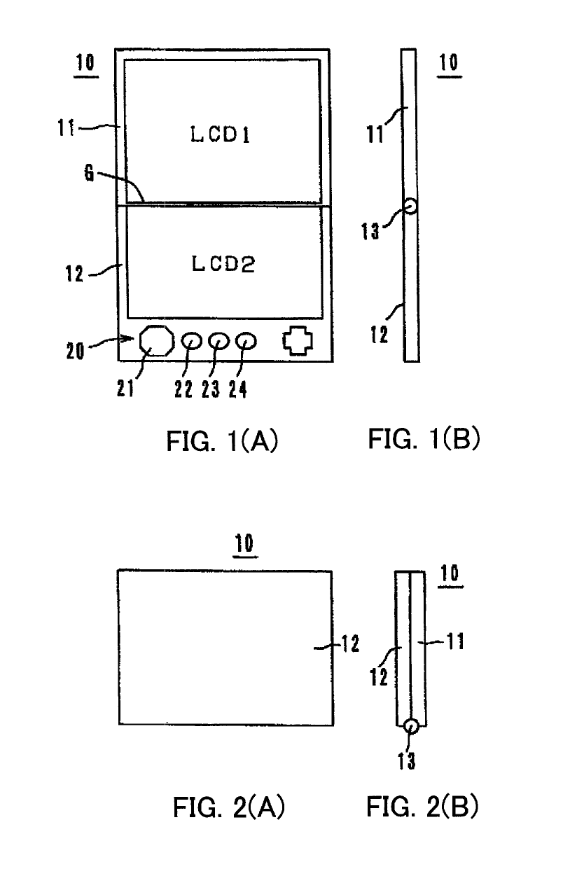

FIGS. 1 and 2 show the external appearance of an information display apparatus 10 reflecting one embodiment of the present invention. This apparatus 10 comprises a first housing 11 having an LCD 1 (the first display) and a second housing 12 having an LCD 2 (the second display) and an operation unit 20, and the housings 11 and 12 are connected to each other by means of a hinge unit 13 such that they can open and close.

In this information display apparatus 10, where the housings 11 and 12 are opened so that they may be used, as shown in FIG. 1, the LCDs 1 and 2 are located next to each other in a vertical alignment. In this state, the LCDs 1 and 2 together comprise an A4-sized screen, for example. When the apparatus is stored, the housings 11 and 12 are folded on top of each other, as shown in FIG. 2, making the apparatus half its previous size, such that it is convenient for storage and portability.

On the operation unit 20 are located a power switch 21, a page forward switch 22, a page back switch 23 and a display information selection switch 24. The page forward switch 22 advances the information display to the next page, while the page back switch 23 returns the information display to the previous page. The display information selection switch 24 selects between the display of information from (i) a memory/reproduction device 32 and (ii) an input unit 33, both of which are described below.

The LCDs 1 and 2 comprise display elements that employ liquid crystal. Each element comprises, for example, chiral nematic liquid crystal that exhibits a cholesteric phase at room temperature held between transparent films, in which the pixels are driven in a matrix fashion through the impression of pulses from scanning electrodes and signal electrodes. The use of chiral nematic liquid crystal enables a color display to be achieved through the stacking of three liquid crystal layers that each selectively reflect light of one of the three primary colors.

The information display apparatus 10 having the construction described above may be used by a user in a stand-alone mode, in a network mode in which it is connected to a LAN comprising a wired or wireless network, or as a display device for an electronic meeting system, which has received attention in recent years.

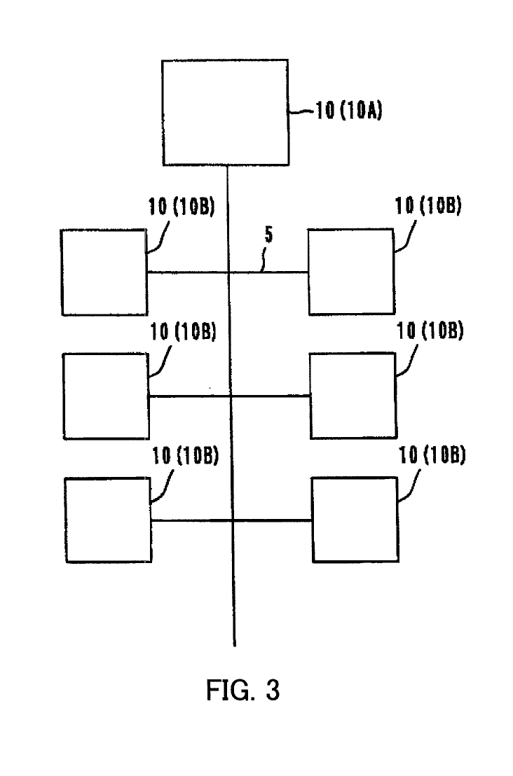

FIG. 3 shows in a simplified fashion the electronic meeting system, wherein the information display apparatus 10 is used as the parent unit 10A, or as one of multiple child units 10B connected to the parent unit 10A over a network 5. The parent unit 10A may have a larger screen than the child units 10B to enable it to be used to make meeting presentations.

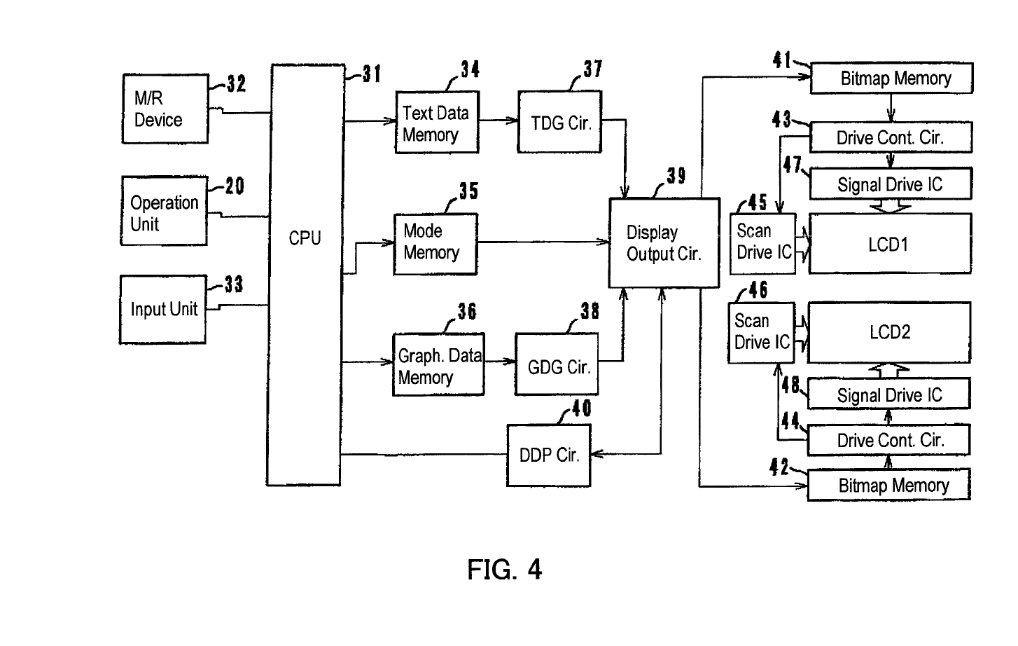

The construction of the controller of the information display unit 10 will now be explained with reference to FIG. 4. The controller comprises the following circuits.

CPU 31: Controls the entire information display apparatus 10. Display information and operation signals are input to this CPU 31 from the memory/reproduction device 32, the operation unit 20 and the input unit 33.

Memory/reproduction device 32: Accepts storage media that are removable from the information display apparatus 10, such as magnetic disks, magneto-optical disks, floppy disks, memory cards, etc., and reads out information stored therein and outputs the information as text data, graphics data, etc.

Input unit 33: Is connected to the network 5, etc. and receives information from external devices as electric signals or optical signals, and outputs the information as text data, graphics data, etc.

Text data memory 34: Stores attribute data indicating character codes and character colors for characters to be displayed.

Mode memory 35: Stores and outputs parameters indicating the display mode. These display modes include a text display mode, a graphics display mode, and a combined display mode in which both text and graphics are displayed at the same time.

Graphics data memory 36: Stores graphics data that defines the color and brightness for each pixel on the LCDs 1 and 2.

Text data generating circuit 37: Reads out data stored in the text data memory 34 and converts this data by means of a character generator into text display data comprising dot patterns.

Graphics data generating circuit 38: Reads out graphics data stored in the graphics data memory 36 and converts this data into graphics display data that specifies the color of each pixel on the LCDs 1 and 2.

Display output circuit 39: Based on the display mode (text display mode, graphics display mode, combined display mode), generates either text display data or graphics display data, or display data combining these two types of data, and outputs it to bitmaps 41 and 42.

Display division processing circuit 40: Working together with the display output circuit 39, divides the text display data and the graphics S display data into parts to be displayed on the LCD 1 (the first screen) and the LCD 2 (the second screen). The division processing referred to here will be described in detail below.

Bitmaps 41 and 42: Stores display data for each pixel sent by the display output circuit 39 to its corresponding address.

Drive control circuits 43 and 44: Comprises shift registers and other components, and splits the display data sent from the bitmaps 41 and 42 into scanning signals and data signals for matrix driving, and sends them to the scanning drive ICs 45 and 46 and the signal drive ICs 47 and 48 in a synchronous fashion.

Drive ICs 45 through 48. Carry out matrix driving of and display images on the LCDs 1 and 2 based on the display data sent by the drive control circuits 43 and 44.

The operation of the information display apparatus 10 controlled by the CPU 31 will now be explained with reference to a flow charts.

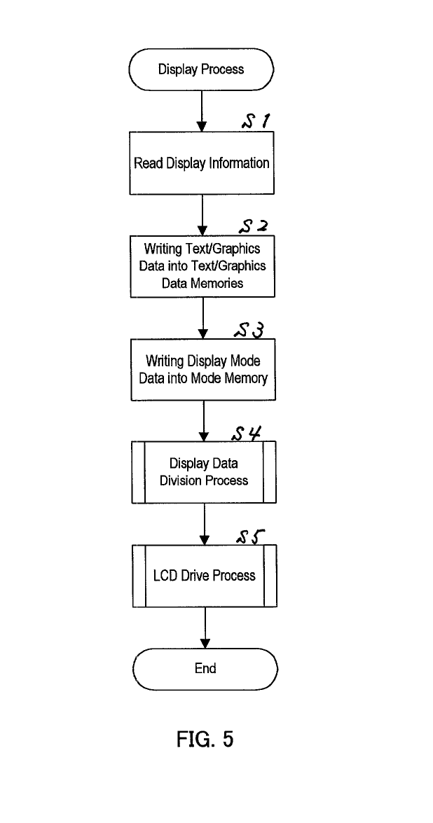

FIG. 5 is a flow chart of the display process performed by the CPU 31. First, in step Si, the display information selected from the memory/reproduction device 32 or the input unit 33 is read in, and in step S2, text data including character codes and attribute data indicating text images are written into the text data memory 34, and graphics data is written into the graphics data memory 36. In step S3, the data to set the display mode is written into the mode memory 35.

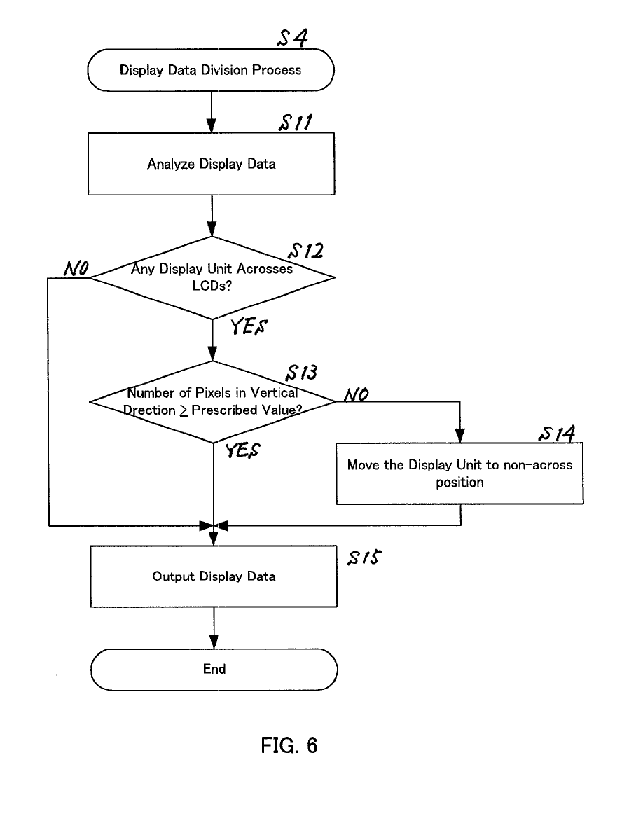

Next, in step S4, the display data division process is performed by the display division processing circuit 40. First, second and third examples of this division process are described in detail below with reference to FIGS. 6, 7 and 8, respectively.

In step S5, the drive control circuits 43 and 44 are controlled based on the display data expanded in the bitmaps 41 and 42, the display data is written to the LCDs 1 and 2, and processing comes to an end.

In the display operation executed in step S4, the text data generating circuit 37 sequentially reads out the character codes and attribute data for the characters to be displayed, expands the character codes into pattern data through character generation, and generates character display data including the display color for each pixel from the attribute data. The graphics data generating circuit 38 sequentially reads out graphics data indicating the display color for each pixel and generates graphics display data.

The display output circuit 39 receive the text display data provided by the text data generating circuit 37, the graphics display data provided by the graphics data generating circuit 38 and the mode data provided by the mode memory 35, and in order to perform text display based on the text display data, graphics display based on the graphics display data, or combined display based on the text display data and the graphics display data in accordance with the display mode indicated in the mode data, converts the text display data, graphics display data or combined display data into display data linked to each pixel of the LCDs 1 and 2.

When this occurs, the display output circuit 39 links the pixel line display data that immediately follows the display data linked to the bottom pixel line of the LCD 1 to the top pixel line of the LCD 2, such that display is performed wherein the two LCDs 1 and 2 function as a single display element.

The first example of the processing routine carried out by the display division processing circuit 40 will now be explained with reference to FIG. 6. First, the display data generated by the display output circuit 39 is analyzed in step S11, and it is determined in step S12 whether a display unit that spans the LCDs 1 and 2 exists. Here, a display unit refers to one character, where the display is a character display. In the case of a graphics display, a continuous graphics display area is deemed one display unit.

This embodiment is described in more detail below using specific values, but these values are only examples, and needless to say, the present invention is not limited to these values.

The LCD 1 has dimensions of 170 mm vertically and 210 mm horizontally, and a pixel density of 1000 by 1240 pixels. The LCD 2 has dimensions of 127 mm vertically and 210 mm horizontally, and a pixel density of 750 by 1240 pixels. Therefore, when aligned vertically (see FIG. 1), the LCDs 1 and 2 have a combined size of 297 mm vertically and 210 mm horizontally, and is used as A4-sized liquid crystal display element having 1750 by 1240 pixels.

Where the LCDs 1 and 2 are opened, due to way the housings 11 and 12 and the hinge unit 13 are constructed, there is a 3 mm gap G between the bottom pixel line of the LCD 1 and the top pixel line of the LCD 2. In terms of pixels, this gap G is equivalent to 18 rows of pixels. Where characters would be divided by this gap G, and the vertical dimension of the divided characters is smaller than the vertical dimension of the gap G, it would be rather difficult to make out the characters subjected to divided display.

Therefore, in the first example, it is determined in step S13 whether or not the vertical height of the display characters is 6 mm (the prescribed value) or higher. In other words, in terms of pixels, it is determined whether or not the vertical height of the characters is greater than 36 pixels, as compared to the 18-pixel vertical height of the gap G.

Where, for example, upper case and lower case letters of the alphabet are mixed together, and where letters having different heights such as ‘h’ and ‘e’ are mixed together, the vertical pixel height of the entire line of characters is determined, not the size of each individual character. This method of determination may be applied to lines comprising characters other than letters, such as “kanji” or “kana.” Moreover, the determination may be made in terms of the actual height of the display on the display screen, rather than in terms of the number of pixels. Furthermore, the determination may be made from the font size or the rate of enlargement or reduction.

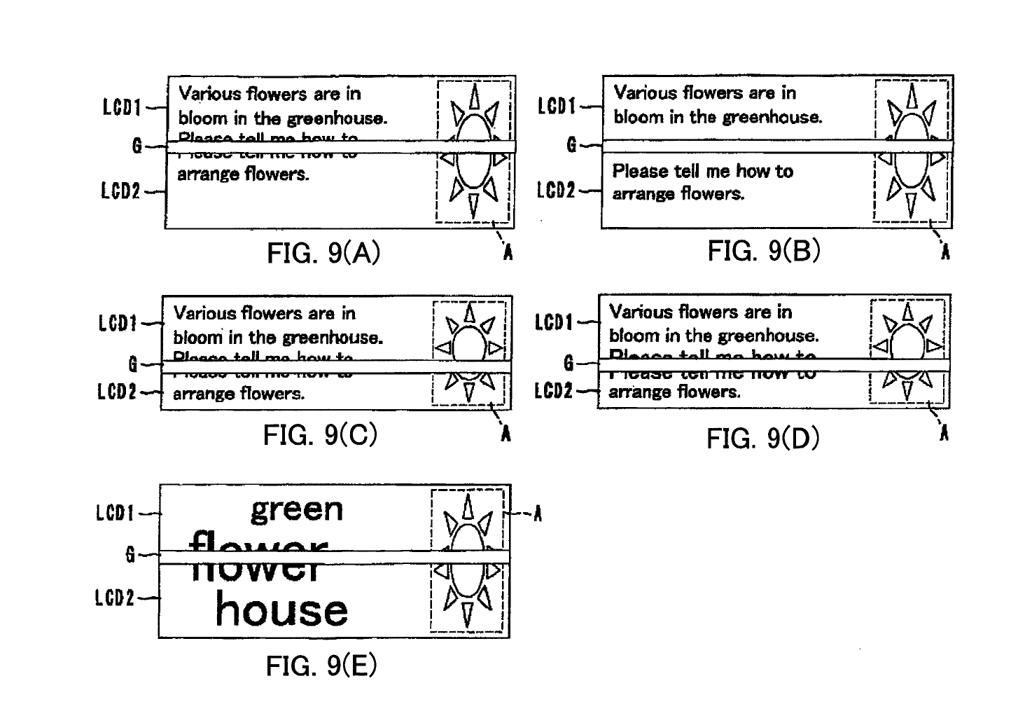

The determination described above is also performed for a continuous graphics area. FIGS. 9(A) through 9(E) show in a simplified fashion parts of the screens of the LCDs 1 and 2 and the gap G where characters and a graphic are displayed on the LCDs 1 and 2. The area A enclosed by a dashed line is the area in which the graphic is displayed.

In step S12, in the case of display data that includes display units that would span across both of the LCDs 1 and 2 without the display division processing, as in FIG. 9(A), where the vertical pixel height of the above display units is determined in step S13 to be smaller than the vertical pixel height of the gap G (the prescribed value), the display units are moved in step S14 to a position at which they will not span both of the LCDs. Specifically, as shown in FIG. 9(B), a process is performed by which the words ‘Please tell me how to’ are moved to the LCD 2. Regarding the graphics data, because the display area A is larger then the prescribed value, it is not moved. As shown in FIG. 9(E), where the display information spanning both LCDs—here, the text data ‘flower’—is larger than the prescribed value from the start, it is not moved. Large character information may be read with little difficulty even when it is separated by the gap G in this way.

After the division processing described above is performed, the display data is expanded in the bitmaps 41 and 42 and displayed on the LCDs 1 and 2 in step S15.

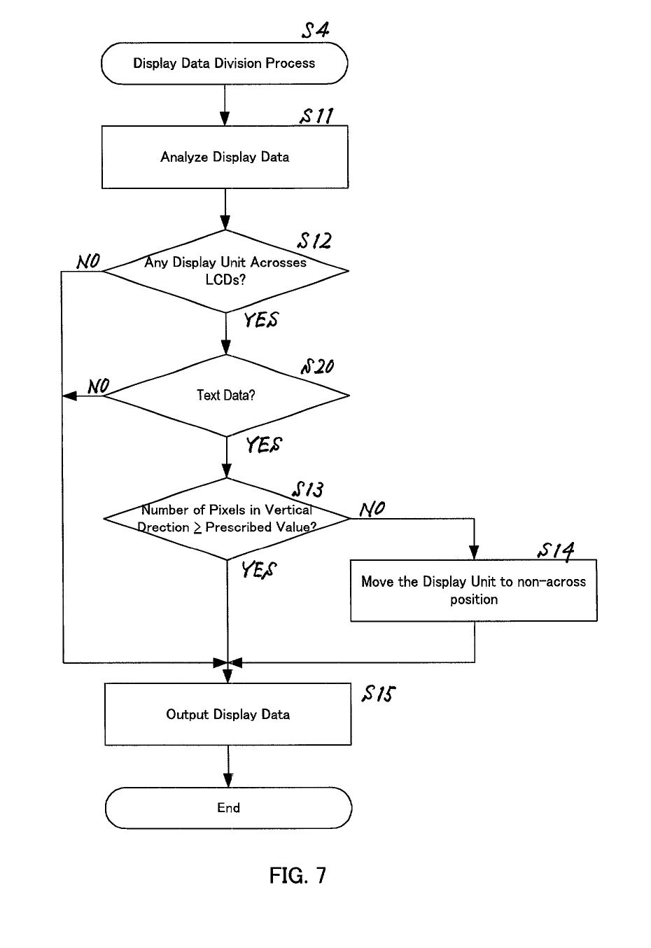

FIG. 7 shows a second example of the processing routine carried out by the display division processing circuit 40. This second example involves essentially the same processing as the first example, except that in the second example, where the display unit would span both the LCD 1 and the LCD 2 without the display division processing, as shown in FIG. 9(A), it is determined in step S20 whether or not the display unit comprises text data, and steps S13 and S14 are performed only if the display unit does comprise text data.

In other words, only text data is moved to the LCD 2 for display if it spans both of the LCDs, as shown in FIG. 9(B). Data other than text data usually consists of graphics data, but because graphics data usually has a large display area and is made out with little difficulty even if it is separated by the gap G, it is not always moved, and it is displayed on the LCDs 1 and 2 as is, i.e., divided by the gap G.

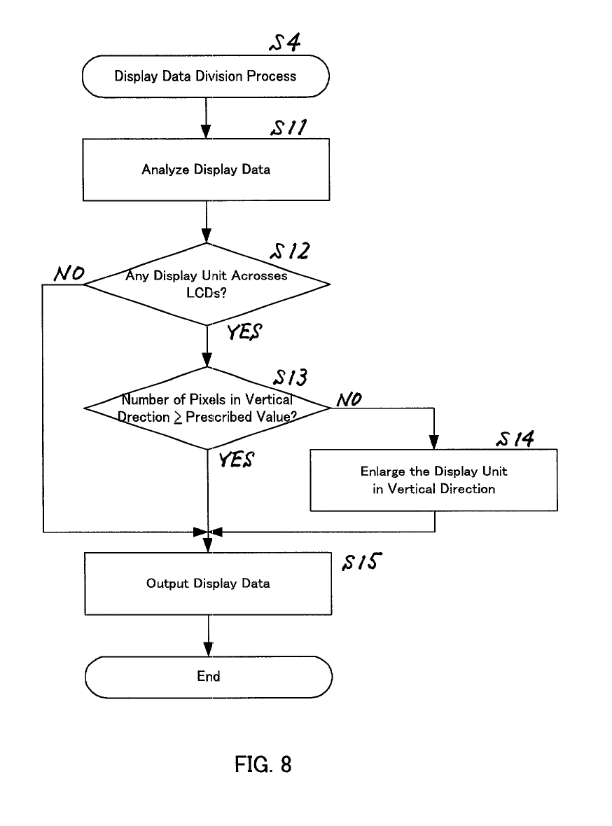

FIG. 8 shows a third example of the processing routine executed by the display division processing circuit 40. This third example involves essentially the same processing as the first example, except that in the third example, the display units that span both LCDs are expanded to a prescribed value in step S14′. As with the relationship between the size of the gap G and the size of the display unit, the prescribed value here is the value at which the display unit is twice the size of the gap G. In order to avoid the need for a carriage return when enlarging the characters, it is preferred that the characters be spaced closer together or that only the vertical height of the characters be increased. Specifically, the display state shown in FIG. 9(C) is changed to the display state shown in FIG. 9(D).

(Other embodiments)

The information display apparatus pertaining to the present invention is not limited to the embodiment described above, and may be varied within the essential scope of its construction.

In particular, because the display size may be freely chosen, the present invention may be applied in various types of information display apparatus, ranging from small, portable devices to large units such as presentation devices. In addition, the construction of the housings of the apparatus and of the hinge unit connecting these housings, as well as the construction of the operation unit and the type of display means, may be freely chosen.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An information display apparatus comprising:
a plurality of display screens for displaying a display frame of display information that is formed of at least one display unit; and
a division processor for dividing the display frame into a plurality of divided frames so that the divided display frames are respectively displayed on the plurality of display screens,
wherein the division processor operates, based on the characteristics of the display information, according to a first process in which the information is processed such that an entire of the at least one display unit belongs one of the display frames, or a second process in which the display information is processed such that, when the at least one display unit reaches a position at which the at least one display unit is to be displayed across the plurality of display screens, the at least one display unit is divided into a plurality of parts and the plurality of parts of the divided display unit respectively belong the divided frames.

2. An information display apparatus as claimed in claim 1, wherein the division processor executes the first process or the second process based on a size of the display unit.

3. An information display apparatus as claimed in claim 2, wherein the division processor executes the first process when the size of the display unit is smaller than a prescribed value.

4. An information display apparatus as claimed in claim 2, wherein the division processor executes the second process when the size of the display unit is larger than a prescribed value.

5. An information display apparatus as claimed in claim 1, wherein the division processor executes the first process or the second process based on a number of pixels of the display unit.

6. An information display apparatus as claimed in claim 1, wherein the division processor executes the first process when the number of pixels of the display unit is smaller than a prescribed value.

7. An information display apparatus as claimed in claim 1, wherein the division processor executes the second process when the number of pixels of the display unit is larger than a prescribed value.

8. An information display apparatus as claimed in claim 1, wherein the division processor executes the first process when the display unit is text data.

9. An information display apparatus as claimed in claim 1, wherein the division processor executes the second process when the display unit is not text data.

10. An information display apparatus comprising:
a plurality of display screens for displaying a display frame of information that is formed of at least one display unit; and
a division processor for dividing the display frame into a plurality of divided frames so that the divided display frames are displayed on the plurality of display screens,
wherein this division processor enlarges the display unit when the display unit originally reaches a position at which the display unit is to be displayed across the plurality of display screens, and divides the enlarged display unit into a plurality of parts so that the parts of the divided display unit is applied to the plurality of display frames.

11. An information display apparatus as claimed in claim 10, wherein the division processor enlarges the display unit when a number of pixels of the display unit is smaller than a prescribed value.

12. An information display apparatus comprising:
a plurality of display screens for displaying a display frame of display information that is formed of at least one display unit; and
a division processor for dividing the display frame into a plurality of divided frames so that the divided display frames are respectively displayed on the plurality of display screens,
wherein the division processor selectively operates in one of a first process and a second process based on a characteristics of the display information,
wherein, in the first process, the division processor processes the display information so that an entire of the at display unit belongs one of the display frames even in a case where the display unit originally reaches a position at which the display unit is to be displayed across the plurality of display screens, and
wherein, in the second process, the division processor processes the display information so as to divide the display unit and applies the parts of the divided display unit to the plurality of display screens in a case where the display unit originally reaches a position at which the display unit is to be displayed across the plurality of display screens.

13. An information display apparatus as claimed in claim 12, wherein the division processor selectively executes one of the first process and the second process based on a size of the display unit.

14. An information display apparatus as claimed in claim 13, wherein the division processor executes the first process when the size of the display unit is smaller than a prescribed value.

15. An information display apparatus as claimed in claim 13, wherein the division processor executes the second process when the size of the display unit is larger than a prescribed value.

16. An information display apparatus as claimed in claim 12, wherein the division processor executes the first process or the second process based on a number of pixels of the display unit.

17. An information display apparatus as claimed in claim 12, wherein the division processor executes the first process when the number of pixels of the display unit is smaller than a prescribed value.

18. An information display apparatus as claimed in claim 12, wherein the division processor executes the second process when the number of pixels of the display unit is larger than a prescribed value.

19. An information display apparatus as claimed in claim 12, wherein the division processor executes the first process when the display unit is text data.

20. An information display apparatus as claimed in claim 12, wherein the division processor executes the second process when the display unit is not text data.
